(19) United States
(12) Patent Application Publication
(10) Pub. No.: US 2012/0095964 A1
(43) Pub. Date: Apr. 19, 2012

(54) SYSTEM AND A METHOD FOR HANDLING CO-OPERATION FILES

(75) Inventors: Per Buus Sorensen, Aalborg SO (DK); Nis Holdt, Ebeltoft (DK)

(73) Assignee: MEDIA4WORK APS, Randers (DK)

(21) Appl. No.: 13/316,674

(22) Filed: Dec. 12, 2011

Related U.S. Application Data
(63) Continuation-in-part of application No. 12/086,044, filed on Jul. 29, 2008, now abandoned.

(30) Foreign Application Priority Data
Dec. 6, 2005 (DK) PA 200501730

(51) Int. Cl. G06F 7/00

(52) U.S. Cl. 707/638; 707/E17.01

(57) ABSTRACT

The invention relates to a method for handling co-operation files between customers and suppliers where a unique ID is attached to the co-operation file. The customer stores co-operation files on a central file handling database and the co-operation files of the supplier are stored on a supplier computer. When a user tries to access the co-operation file stored on the supplier's storage medium, the user is informed if a version of the co-operation file stored on the central file server differs from the version of the co-operation file stored on the supplier's storage medium.

### CROSS REFERENCE TO RELATED APPLICATIONS

This application is a continuation in part of U.S. patent application Ser. No. 12/086,044 filed on Jul. 29, 2008, which claimed priority from PCT/DK2006/000663 filed on Nov. 28, 2006, the contents of each of which is incorporated herein by reference in their entirety.

### BACKGROUND

1. Field of the Invention

The present invention regards a system and a method for handling co-operation files, where the co-operation files are files that represent the co-operation basis for co-operation between document owners and document users.

2. Background of the Invention

When a co-operation between customers (the document owner) and their suppliers (the known document users) and sub suppliers (the unknown document users) exists, a co-operation file has been devised as a basis for this co-operation—e.g. printing instructions, drawings or production instructions describing how items are to be used and/or manufactured. The co-operation file is usually transferred to the supplier in electronic form and the item of the supplier is then manufactured on basis of this electronic production bases, also designated a co-operation file, that describes the co-operation basis relating to the co-operation between the customer and the supplier.

One problem in this regard occurs in that many companies that use suppliers and sub-suppliers send new versions of their electronic co-operation file, or send a message that a new version exists, to their suppliers. However, the companies may not be aware that their supplier uses sub suppliers and therefore the sub supplier may not receive the new information, or the suppliers and sub-suppliers receive the information much before they are to use them and thus need to manage the information from the time they receive it and until they are to use it.

A further problem is that suppliers or sub suppliers would often use an existing electronic co-operation file already held by the supplier. This has the effect that the product delivered to the company is manufactured on the basis of an outdated electronic co-operation file, which again means that the product needs to be re-manufactured on the basis of the correct co-operation file—again resulting in delays and increased costs.

Another problem occurs in that the company often does not know the actual supplier as this supplier is a supplier to the supplier. The supplier, and more decisively the sub supplier, often has problems finding the electronic co-operation file for the product, even though the customer has made the file public. The supplier and the sub supplier then often tend to use the first co-operation file that comes in hand which is very often defective, thus resulting in items that are not uniform among suppliers.

Another problem arises when a company uses more suppliers that are all using the same sub suppliers. When a company wishes to change supplier, the company may not change sub supplier. However, the company does not know whether this is the case or not. This results in the company asking its supplier to provide the electronic co-operation file. The sub supplier provides the supplier with the co-operation file and the supplier delivers it to the company. The company then sends the co-operation file to its new supplier which then sends it to the original sub supplier with big costs as a result.

Another problem is that the document users might rename the co-operation files to follow own naming standard. They might also amend the files with own modification which are specific for the document user and not related to the document owner and other users.

Another problem is that the document owners can't control which software the document users choose to use to access the files or where they store the co-operations files

Another problem in relation to co-operation files is that the document owners don't know who is using the co-operation files. If no one is using the co-operation files, the document owner could save costs by marking them as obsolete.

WO 01/67279 describes a system and a method for building a database for the design and execution of projects. The system is used when working on a project by a number of project members; the project members are defined on a central database and each time a project file is amended, the project members receive a message. Problems with this system is that only predefined project members are informed about the updates, and therefore any other party accessing project files will not know about any updates. Further, because the system transmits updates each time a project file is updated, all project members receive a lot of messages, which could be irrelevant to some members and where the large amount of messages further affects the performance of the system.

US Publication No. 2002/0174180 describes a system and a method where the co-operation files are synchronized between different known partners. Problems with such a system is that files are synchronized even if they are not used, which uses unnecessary resources. The system only works as long as files are accessed from the predefined location (synchronization directories) by the predefined partners.

U.S. Pat. No. 7,0,58,696 describes a system and a method where the co-operation are located on a central server and accessed through a virtual drive on the system. Such a system could have performance issues when handling large files. It also have the same problem as the previous patent since system only works when files are accessed from the predefined location (the virtual drive) by the predefined partners. If a file is moved to another location, like a local hard drive, the system will not work.

### OBJECT AND DESCRIPTION OF THE INVENTION

It is the object of the invention to provide a solution to the above-mentioned problems:

This can be done by a method for handling co-operation files; where the content of the co-operation files is of the type that describes the co-operation basis in relation to a co-operation between document owners and document users, and where a unique ID is attached to a co-operation file, where the document owner stores the unique ID in a central file handling database and where the co-operation files of the document owner are stored on the owners locale computer system, the method comprising:
checking if a co-operation file exists on the central database with an ID matching the ID of the co-operation file stored on the document owner's storage medium where the checking is initiated by the document user trying to access the co-operation file stored on the document users storage medium,
informing the user of the document if a newer version of the document exists.

This will ensure that suppliers and sub suppliers always use the correct version of the co-operation file. Further, suppliers and sub suppliers do no longer have to control whether they are in possession of the newest version of a co-operation file. Further, the document owner does not have to keep track of who the supplier or sub supplier is, or if new suppliers or sub suppliers are involved, as long as they have delivered other items to the document owner before, as in this case the supplier or sub supplier would know where to retrieve the co-operation file. In other words, the supplier and sub supplier only have to be informed once that the company uses a file handling database, and it is ensured that suppliers and sub suppliers use a uniform co-operation file. A further advantage is that only when the user is trying to access a locally stored co-operation file, the version checking is performed, and the user is informed if the locally stored version is an outdated version.

A co-operation file might be a logo design, measurements, architect drawings, printing designs, diagrams and other documents used as the basis of a co-operation between suppliers and their customers.

A unique ID is something that identifies a co-operation file so that the co-operation file can be distinguished from other co-operation files. The ID is a hash value calculated from the actual contents of the file itself.

A further advantage is that suppliers and sub suppliers are notified if a newer version of the electronic co-operation file exists or is under construction. Further, this means that suppliers and sub suppliers have to retrieve the co-operation file from one place only no matter to which company the product is manufactured. The final product manufactured for the client will therefore be uniform, no matter where in the world it is manufactured.

A further advantage is that companies that wish to give their suppliers and sub suppliers access to their co-operation files do not necessarily make information from their core business vulnerable to unauthorized use and is placed with a third party where the central file handling database of the third party is secured against unauthorized use.

A further advantage is that the document owner does not have to send the electronic co-operation file to all suppliers and sub suppliers. The document owner only needs to upload the new file ID to the central file server. In a specific embodiment of the invention the message to the document user's computer comprises transfer of the co-operation file with the newer version number to the document user's computer. Hereby it is ensured that the user can only access the newest version and that this version is locally accessible without the user having to take further action.

In a specific embodiment of the invention the comparison of the version number further comprises an investigation as to whether a new co-operation file is under construction through a construction identification attached to the file and stored on the central database, and if this is the case a message is sent to the document user's computer. In this way the user is made aware, simply and quickly, that the version that is accessed is being changed and thus a lot of unnecessary work is avoided. The user might choose to postpone his work until the co-operation basis is completed.

The invention further relates to a computer readable medium having stored therein instructions that will make a processing unit perform the method as described above.

The invention further relates to a co-operation file of the type which describes the co-operation basis in relation to a co-operation between document owners and document users and where a unique ID and a version number are associated with the co-operation file, where the co-operation file is adapted to be used in a method a described above.

In an embodiment the co-operation file is associated with an identification of the person having created the file. Hereby it is possible for the person accessing the file to identify the person having created the file and to get in contact with this person if there are any questions concerning the amendments.

The invention also covers a system for handling co-operation files where the content of the co-operation files is of the type that describes the co-operation basis in relation to a co-operation between document owners and document users, and where a unique ID is associated with a co-operation file, where the document owner stores co-operation files ID on a central file handling database and where the co-operation files of the owner are stored on the owners local computer system, the system comprising:
a processor adapted to check if a co-operation file ID exists on the central database with an ID matching the ID of the co-operation file stored on the document user's storage medium where the check is initiated by the user trying to access the co-operation file stored on the user's storage medium,
a processor adapted to inform the document user if a newer version of the co-operation file exists.

### BRIEF DESCRIPTION OF THE DRAWINGS

In the following the invention will be described in details referring to the drawing on which:

FIG. 1 shows a system for handling co-operation files,

FIG. 2 shows a diagram of a method for handling co-operation files,

FIG. 3 shows a flow diagram for the functionality of the system, when a document user wished to access a co-operation file,

FIG. 4 shows a flow diagram for the functionality of the system, when a document owner wishes to change the co-operation file,

FIG. 5 shows a flow diagram illustrating the interaction between the document user's computer and the central file server,

FIG. 6 shows a more detailed flow diagram illustrating, by way of example, the interaction between the document user's computer and the central file server.

### DETAILED DESCRIPTION OF EMBODIMENTS OF THE PRESENT INVENTION

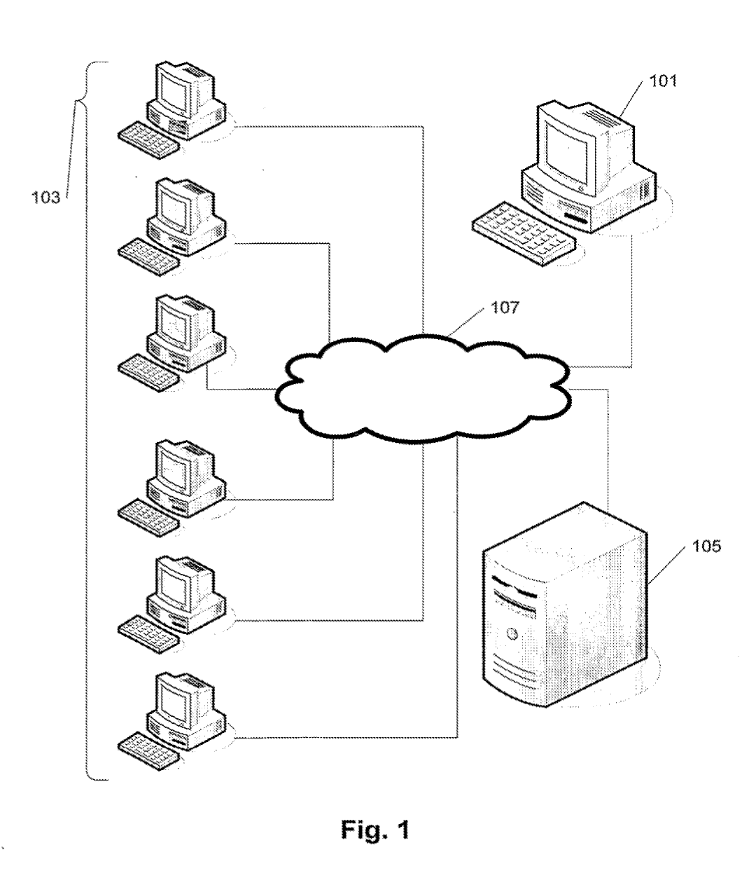

FIG. 1 shows a system for handling co-operation files where the system comprises a document owner computer 101, a number of document user computers 103 and a central file ID server 105. All computers are linked together by a network, for example the Internet 107.

The central server, which can be accessed from both the document owner's and the document user's computer via the Internet, stores all co-operation file ID's for all document owners that are using the system. When a co-operation file has been created the unique ID is stored on the central server.

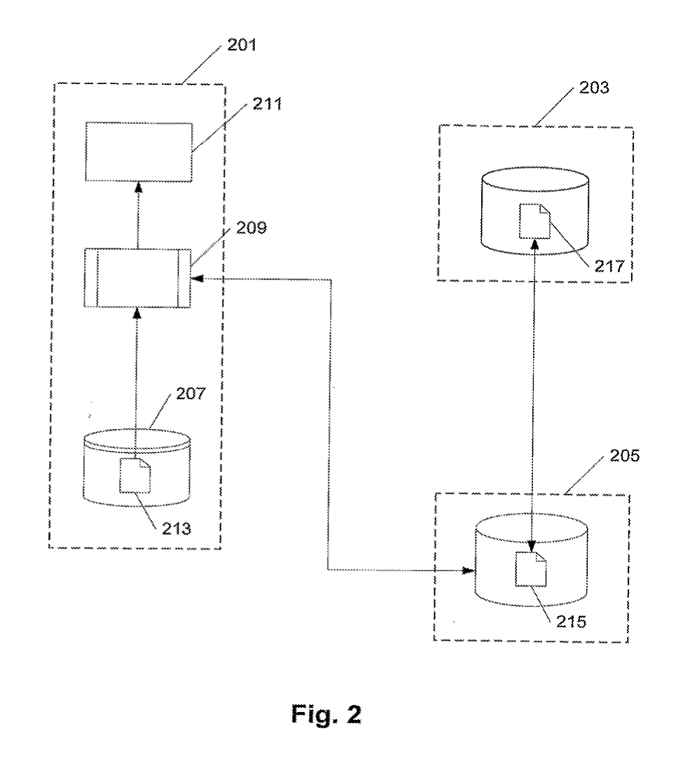

FIG. 2 shows a diagram of the method for handling co-operation files. A supplier or sub supplier is to start working on an item described in a co-operation file 213 stored on the supplier computer's 201 storage medium 207. Before the supplier gets access to the co-operation file 213, it is checked in 209 if a newer version of the file exists on the file server 205. This can be done in that the co-operation file has a unique ID and where the co-operation file attached to the ID is compared to the version of a co-operation file on the file ID server 205.

The investigation in 209 can be done by a piece of software installed and activated on the document user's computer 201. The functionality of the software is that every time access to a file in the storage medium 207 is desired, it is detected whether access is wanted to co-operation files. In case of a co-operation file, a request is sent to the central file server 205 in order to detect whether a newer version of the co-operation file is stored on the central file ID server 205. In order to ensure that two co-operation files are not mixed up, the co-operation may be provided with a unique ID and the request for files is made on the basis of their unique ID. On the central file ID server 205 it is checked whether a newer version of the co-operation file is stored thereon, and a message is sent to the document user computer 201 telling it whether or not a newer version is available on the file server. Finally, the document user computer 201 notifies the user via a user interface. The entire comparison of the version takes place automatically when access to the co-operation file is sought, and it is hereby ensured that the document user has always access to and is aware of the existence of newer versions of the co-operation file.

The investigation in 209 is transparent to the document user the same way as virus check software is transparent to the user. If the document user's version of the co-operation file is identical with the version on the central file server, and a new version of the co-operation file is not under construction, nothing happens. If a new version is under construction, the document user might contact the company for further information as to whether the existing version is to be used or whether the document user should wait for the version under construction. If a new version exists, the document user will be asked if he wants to download the newest version.

The investigation in 209 will be performed regardless of which software program the document user uses to access the file. The file can be stored on any location and on any storage medium like a locale hard disk, a server drive, a USB drive, DVD or even on the internet. The document user may have renamed the file to follow own naming standards or even added own modifications to the file.

The file ID server can contain co-operation file ID's for several document owners where the co-operation files may be categorized logically and via searching facilities the users will always find the newest version of the co-operation file possessed by the client.

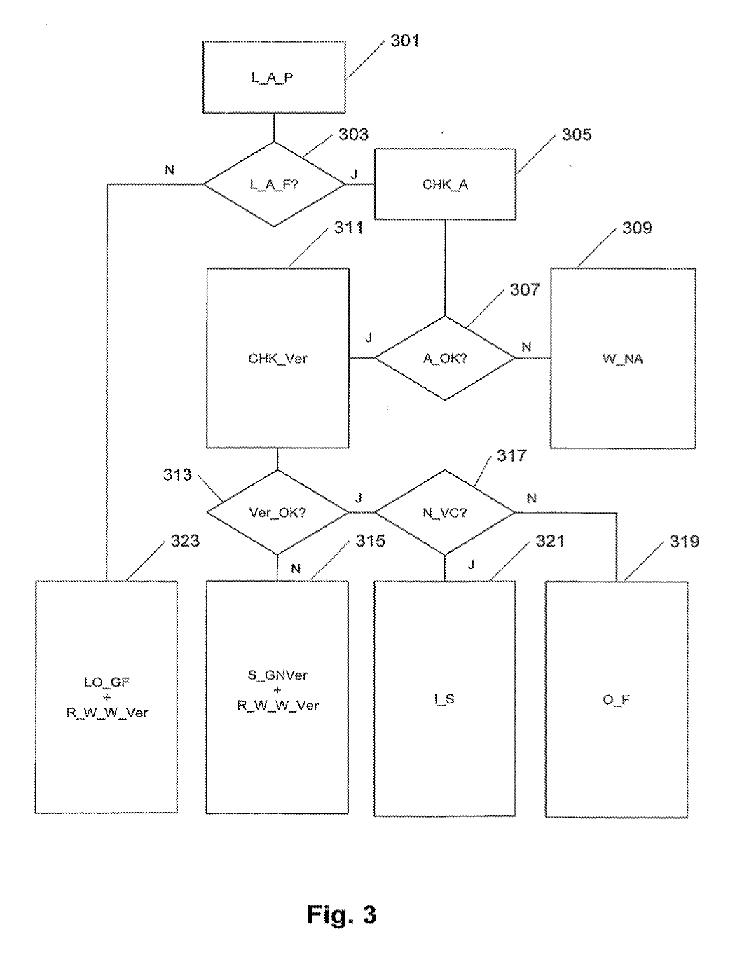

FIG. 3 shows a flow diagram of the functionality of the system when a document user accesses a co-operation file. In 301 the procedure is activated in that the document user wants to access a co-operation file (L_A_P). In 303 it is checked if the co-operation file is already stored on the document user's storage medium (L_A_F). If this is not the case 323, connection to the central file server is established and the co-operation file with a unique ID is copied to the document user's storage medium. In an embodiment it is registered who copies the co-operation file, when it is copied and which version is copied (LO_GF+R_W_W_Ver).

If the document user already has the co-operation file, it is checked 305 if access to the central file ID server can be established (CHK_A). In 307 this is checked (A_OK) and if a connection is not possible 309, the document user gets a warning via a user interface on the document user computer that access cannot be established and thus that there is no guarantee that the co-operation file on the document user's storage medium is the correct version (W_NA). If connection is established 311, it is checked whether the version of the co-operation file on the document user's storage medium is newest version (CHK_Ver). The investigation is done in 313 (Ver_OK). If it is not newest version 315, the supplier is urged to download the newest version from the central file server using the user interface on the document user computer. If the co-operation file is copied from the central file server, it is logged who copies the file, when it is copied and which version is copied (S_GNVer+R_W_W_Ver). If the same version is stored on both servers, it is in 317 checked if a new version of the co-operation file is under construction (N_VC). If this is the case, the document user is urged, via a user interface on the document user computer, to contact the document owner as it may be better to wait until the new version is ready. If a new co-operation file is not under construction 319, the co-operation file on the document user's storage medium is opened without further notice, and in one embodiment the document user will not even notice that the investigations have taken place.

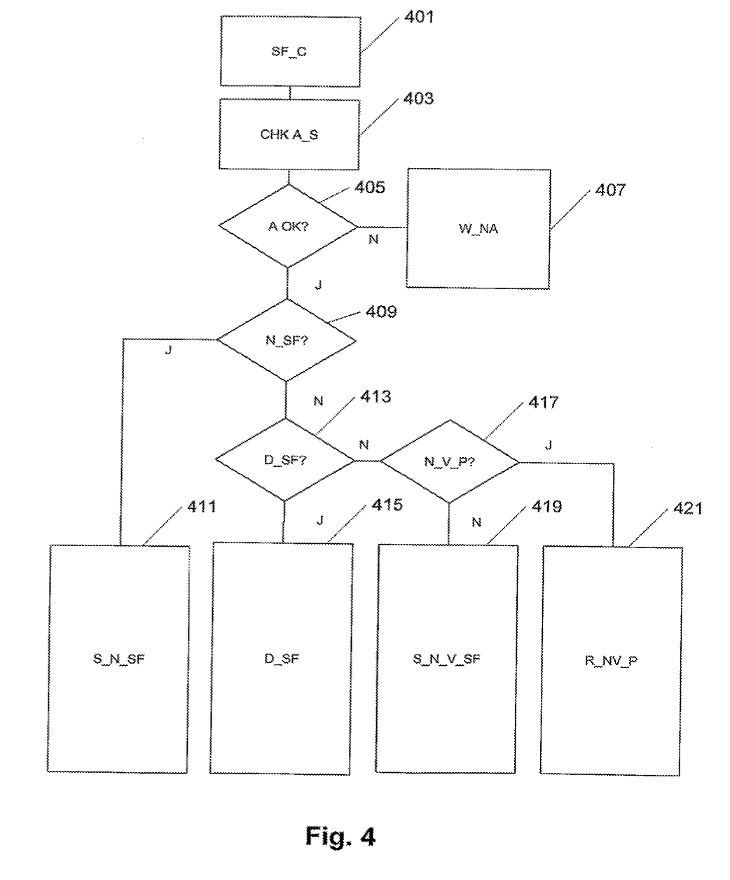

FIG. 4 shows a flow diagram of the functionality of the system, when a document owner wants to change the co-operation file. In 401 the document owner has created, changed or deleted a co-operation file stored on the document owner's storage medium (SF_C). In 403 it is checked if a connection to a central file ID server with a file handling database can be established e.g. via the Internet (CHK A_S). In 405 the connection is checked (A_OK). If no connection can be established 407 the document owner gets a warning that the co-operation file ID cannot be updated on the server. If a connection is established 409, it is checked in 409 if it is a new co-operation file (N_SF). If it is a new co-operation file 411, the document owner copies the new file ID to the central file server. In an embodiment it is logged who copies the file and when it is done (S_N_SF). If it is not a new co-operation file it is in 413 checked if the co-operation file has been deleted (D_SF). If this is the case 415, the co-operation file on the central file server is marked as deleted (D_SF). It is further logged who has deleted the file and when it has been done.

If it is not because the co-operation file has been deleted, it is in 417 investigated if a new version of the co-operation file is under construction (N_V_P). If this is the case 421, the document owner copies the co-operation file ID to the central file server and marks it as being under construction (R_NV_P). If the co-operation file is not under construction—but completed 419, the document owner copies the new co-operation file ID to the central file server (S_N_V_SF). In both cases it is logged who copies the co-operation file ID to the central file server, when it is done and what it replaces.

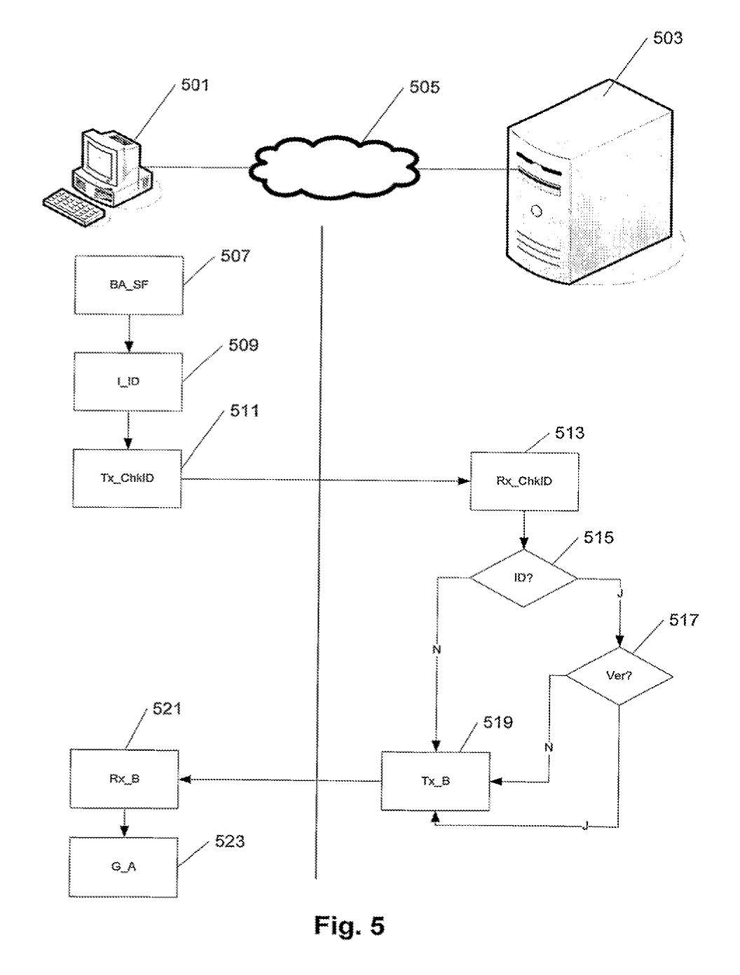

FIG. 5 shows a flow diagram illustrating the interaction between the document user's computer 501 and the central file ID server 503 communicating via the Internet 505.

In 507 the document user computer 501 wants to access a co-operation file (BA_SF); whether or not a file is a co-operation file can e.g. be identified via connected file ID. In 509 a unique ID (I_ID) for the co-operation file is identified and in 511 a request (Tx-ChkID) is transmitted to the central file server 503 along with the ID of the file.

In 513 the central file server 503 receives the request (Rx-Chk_ID) and in 515 it is checked if a file with the same ID is known to the central file ID server 503. If this is not the case 519 a message (Tx_B) is sent to the document user computer 501. If a co-operation file with the same ID is known to the central file ID server it is checked in 517 whether the co-operation file known to central file server 503 has been changed compared to the co-operation file on the document user's computer 501. If this is the case a message is sent 519 to the document user computer announcing this, and if this is not the case a message is sent 519 to the document user's computer announcing this.

In 521 the document user's computer 501 receives the messages (Rx_B) from the central file ID server 503. The document user's computer then informs the user and grants access 523 to the co-operation file (G_A).

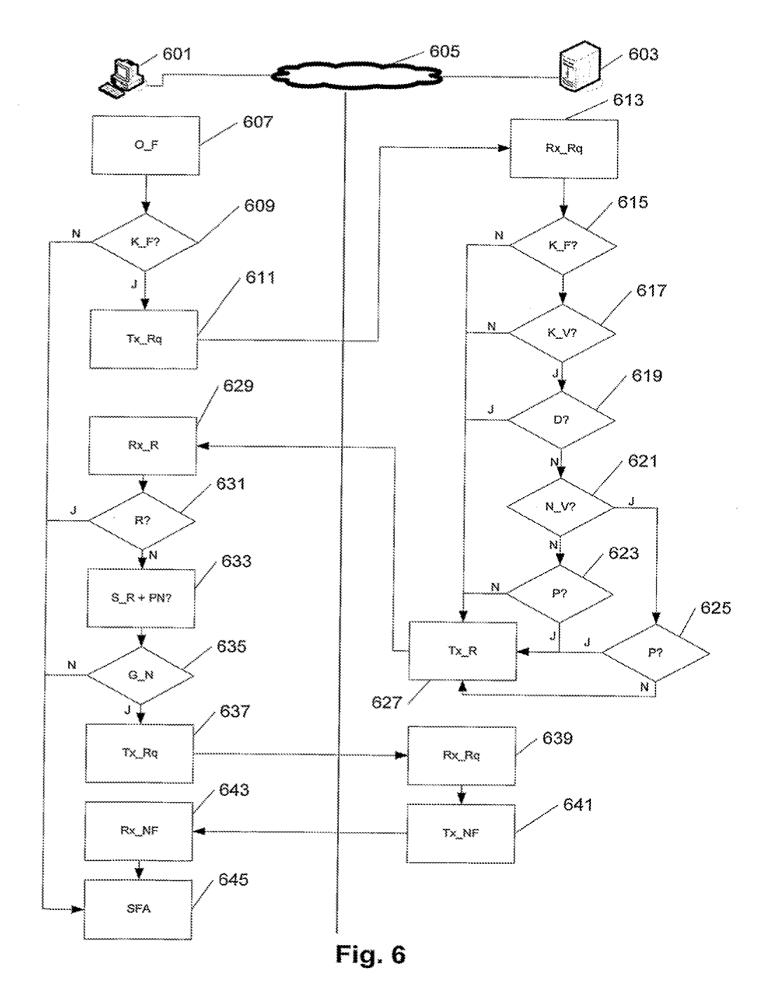

FIG. 6 shows a more detailed flow diagram illustrating by way of example the interaction between the document user's computer 601 and the central file ID server 603 communicating via the Internet 605.

In 607 the document user 601 wants to access a file (O_F). In 609 it is investigated if the file is a co-operation file (K_F) of the type managed by the central file ID server. If this is not the case (N) the desired file can be accessed without further notice in 645 (SFA). If the file is a co-operation file (J) in 611 a request (Tx_Rq) is sent to the central file ID server 603.

In 613 the central file ID server 603 receives the request (Rx_rq) and in 615 it is checked whether it is a known file. If this is not the case (N) in 627 a message (Tx_R) is sent to the document user's computer that the co-operation file is not known to the central file ID server.

If the co-operation file is known (J) it is in 617 checked if the version number is newest version (K_V?). If this is not the case (N) a message is sent to the document user's computer indicating that the co-operation file has been updated and the document user is given the possibility of downloading the newest file or alternatively marking the file ‘private’.

If the co-operation file version is known to the central file ID sever (J) it is in 619 investigated if the version is new (N_V?). If this is not the case (N) it is in 623 investigated if a new version is under construction (P?). If this is the case (J) in 627 a message is sent to the document user telling that a new version is under construction. Furthermore, a notice containing contact information for the document owner may be sent so that the document user can contact the owner for the correct action. If a new version is not under construction (N) the document user's computer opens the co-operation file from the document user's storage medium in 645 (SFA).

If it is a new version (J) it is in 625 investigated if a file is under construction (P?). If this is the case (J) in 627 it is notified that a new version exists and it is offered that this version may be downloaded; furthermore it is notified that a revision is in progress. If a file is not under construction (N) it is in 627 notified that a new version exists and it is offered that this version may be downloaded.

In 629 the document user's computer 601 receives a message from the central file ID server 603. In 631 it is checked if the message notifies that the current version of the co-operation file on the document user's storage medium can be accessed (R?). If this is the case (J) the co-operation file is accessed in 645 (SFA). If this is not the case the message is in 633 shown to the document user and the document user should be asked if he wants to download the new file (S_R+PN). This request (G_N) takes place in 635. If the document user chooses not to download the new file (N), the existing co-operation file is accessed in 645 (SFA). If the document user chooses to access the new file, a request (Tx_Rq) is sent to the central file ID handling database 637. This message is received (Rx_Tq) in 639 where the central file handling database acknowledges the message by returning the new file (Tx_NF) in 641. The supplier computer receives the file (Rx_NF) in 643 and opens the file (SFA) in 645.

In sum, and as examples of the application of the disclosed embodiments, checking is initiated by a document user/supplier trying to access a co-operation file stored on supplier's storage medium. Even when a file is moved from one location to another on the supplier's storage medium, the system will synchronize the co-operation file with the file stored on the document owner/customer's central file server, disclosed above as the central file ID server. The supplier's storage medium can be, for example, the supplier's virtual hard drive that is not linked to the central file server, the supplier's actual hard drive or other supplier side storage medium.

If the co-operation is stored on an actual hard drive for the supplier and the file is outdated, as soon as the supplier attempts to access the file, the system notifies the supplier that the file is outdated. The system immediately offers the supplier the option to download the updated version via, for example, a pop-up window on the supplier's graphical user interface (GUI). The system then downloads the newest version of the co-operation file onto the supplier's storage medium. The system thereafter provides the user with notice, for example, via another pop-up window on the supplier's GUI, that the newest version of the co-operation file is on the supplier's medium. The newest version of the co-operation file may be added to the same file folder on the supplier's medium as the outdated version.

As an example, the supplier attempts to open “ver1.doc” of the co-operation file stored on the supplier's medium, and the owner's central file server's copy is “ver4.doc.” This file identifier, which is the file's name in this example, indicates that versions 1, 2 and 3 of the co-operation file are outdated. Note that while a document name is reference for determining the version, version information in the above disclosure is within the document's unique ID. The system downloads the newest version, e.g., “ver4.doc” onto the supplier's medium, to the same folder/subfolder containing the supplier's outdated version. The outdated version may remain as a separate file or may be deleted. Either way, the system allows the supplier to open “ver4.doc” of the co-operation file stored on the supplier's medium. Upon opening the newest version of the co-operation file, the system may not provide an additional notification to the supplier about the status of the co-operation file, because the supplier has the newest version.

The above synchronization and notification process occurs even if the outdated co-operation file is moved to a different folder/subfolder on the supplier's medium, or across medium platforms before access is attempted by the supplier. The synchronization will also occur if the file is moved and thereafter renamed before access is attempted. The name and physical location of the file on the supplier's medium is irrelevant. The co-operation file can have substantially any name and be located on a hard drive, virtual drive, USB (universal serial bus) flash drive, CD Rom, or other supplier side medium.

Moreover, the synchronization and notification process occurs if the supplier tries to access the file in a preview mode in an email attachment. For example, the supplier receives the co-operation file from another supplier as an attachment in an email delivered to Microsoft Outlook on the supplier's email server, and the co-operation file is outdated. When the supplier attempts to access the file in a preview mode, that is, before downloading the file to the supplier's medium, the system recognizes the file as a co-operation file, and notifies the supplier that the file is outdated. The system provides the supplier with the option to download the newest version to a location of choice by the supplier on the supplier's medium. This same notification and updating process occurs if the supplier attaches an outdated version of the co-operation file to an outgoing email being prepared by the supplier. When preparing an outgoing email, the system is capable of dropping the updated version of the co-operation file directly in the email, if that is the location of choice by the supplier.

In addition, the above synchronization and notification process occurs regardless of the file type. The co-operation file can be a Microsoft Word file or an Adobe PDF file created from the Word file, as just two examples. Access can be through the native application (for example, Microsoft Word, Adobe Acrobat) or through a file manager (Microsoft Windows File Explorer), but these are not limiting examples. The same synchronization process occurs with the same GUI notifications.

As can be appreciated from the above disclosure, no matter how the supplier tries to access the file, where the supplier tries to access the file, or how it is renamed, the system will check the file against the version on the central server.

In the above it is described that the document user retrieves the file from the central file ID server. In another embodiment, the supplier may access the file by online opening of the file placed on the central file ID server. What is important is that the document user gets access to the newest version of the co-operation file.

The disclosed embodiments may be configured in other specific forms without departing from the spirit or essential characteristics identified herein. The embodiments are in all respects only as illustrative and not as restrictive. The scope of the embodiments are, therefore, indicated by the appended claims and their combination in whole or in part rather than by the foregoing description. All changes that come within the meaning and range of equivalency of the claims are to be embraced within their scope.

We claim:

1. A method for handling co-operation files, where content of at least one co-operation file stored on a document user's storage medium associated with a document user's computer describes a co-operation basis relating to a co-operation between at least one document owner and the document user, where a unique ID is associated with the co-operation file, and where the document owner is capable of storing one or more co-operation file ID's on a central file ID handling server database, the method comprising:
checking if the co-operation file ID exists on the central file ID server and if this file ID points to a newer version of the co-operation file;
where the checking is initiated only when the document user tries accessing the co-operation file using any program and the co-operation file being stored in a directory or folder on any storage medium, including the local hard disk, a network drive, a DVD, a USB stick or directly on the internet; and
informing the document user if a newer version of the co-operation file exists.

2. A method according to claim 1, where the document user is informed if a co-operation file having an ID corresponding to the ID associated with the co-operation file stored on the document user's computer does not exist on the central file server.

3. A method according to claim 1 where if the ID points to a newer version of the co-operation file, the newest version of the co-operation file is transferred to the document user's computer.

4. A method according to claim 1 where the document user is informed if a version of the file on the central file server is under construction, is obsolete or has been redrawn.
